(19) United States
(12) Patent Application Publication
(10) Pub. No.: US 2002/0150763 A1
(43) Pub. Date: Oct. 17, 2002

(54) Thermoforming multilayer film for protecting substrates, and objects obtained

(75) Inventors: David Silagy, Evreaux (FR); Frank Bertoux, Puteaux (FR); Phillipe Bussi, Bernay (FR); Anthony Bonnet, Serquigny (FR)

Correspondence Address: MILLEN, WHITE, ZELANO & BRANIGAN, P.C., 2200 CLARENDON BLVD., SUITE 1400, ARLINGTON, VA, 22201, US

(73) Assignee: ATOFINA, Puteaux (FR)

(21) Appl. No.: 10/051,291

(22) Filed: Jan. 22, 2002

(30) Foreign Application Priority Data
Jan. 22, 2001 (FR) 0100879

(51) Int. Cl. B32B 27/08

(52) U.S. Cl. 428/421; 428/476.3; 428/475.8; 428/476.1; 428/476.9

(57) ABSTRACT

A thermoforming multilayer film comprising successively: at least one layer chosen from layers A1 and A2, an optional layer B1, a layer B2, a layer B3, and an optional layer B4. A1 comprises a fluoropolymer A111 or a polymer A112 consisting essentially of alkyl(methyl)acrylate units or a blend of the two, layer A2 consists of ink, layer B1 comprises a fluoropolymer B111 or a polymer B112 consisting essentially of alkyl(meth)acrylate units or a blend of the two, layer B2 is based on a polyamide, layer B3 consists of polyolefin functionalized with unsaturated carboxylic anhydride and layer B4 comprises polyolefin. A process for producing the multilayer film comprising co-extrusion is described.

### FIELD OF THE INVENTION

The present invention relates to a thermoforming multilayer film for protecting substrates, and to the objects thus obtained.

These films may be used in particular in the construction and transport sectors. Many plastic bodywork components are used in particular in the motor vehicle industry, such as bumpers, rear-view mirrors, the bonnet and other components such as the doors and wings, not forgetting the visible components inside the driving compartment. These components have the advantage of being lighter than equivalent components made of steel, of being corrosion-proof and of having better mechanical properties. These components are produced by melt-injection moulding and/or thermoforming thermoplastic material. However, a technical difficulty exists, namely that it is much more difficult to paint them than to paint steel. One solution consists in coating these components with a coloured or decorated film, this possibly being a monolayer or multilayer film. Usually, this film is placed at the bottom of a mould and the molten plastic (the substrate) is then injected therein and, after cooling and removing from the mould, the component coated with the coloured film is obtained; this is the technique of insert moulding. The adhesion of the film is ensured by placing the molten plastic in contact with the film, causing fusion of the surface of the film on the side of the injection of the molten plastic and thus welding. It is also possible to co-extrude the substrate and the coloured film, to layer the substrate on the coloured film or to hot-press the substrate onto the coloured film and then optionally thermoform the assembly.

The present invention relates to these films and to the substrates coated according to this technique.

### PRIOR ART

U.S. Pat. No. 5,514,427 proposes to use the technique known as the <<solvent cast>> technique to disperse the pigments, colorants and fillers uniformly in a multilayer film. The solvent cast technique consists firstly in producing a liquid composition of thermoplastic polymer in a solvent containing the actual polymers, the dispersion of pigments and the additives corresponding to a given specification. This liquid composition is then placed uniformly on a band conveyor. This conveyor is brought into a drying oven in which the solvents are extracted by evaporation and in which the composition is melted to form a continuous layer. The continuous film is then rolled up. The structure of the film comprises, from the inside (substrate side which is made of polyolefin or acrylonitrile butadiene styrene) outwards, a layer of chlorinated polyolefin, an adhesive acrylic layer and a pigmented layer based on fluoropolymer and on alkyl methacrylate.

Patent WO 99/37479 discloses a multilayer film obtained by the <<solvent cast>> technique and lamination, which has, from the inside (substrate side) outwards, respectively, an adhesive layer of the <<pressure sensitive adhesive>> type, a layer of opaque pigmented fluoropolymer in which the fillers have no particular orientation, and a fluoropolymer-based transparent layer.

Patent EP 949120 proposes a multilayer film consisting, from the inside outwards, of a support polymer layer (polyolefin, acrylonitrile butadiene styrene, polyamide, etc.), a base methacrylic layer, a pigmented fluorolayer (with no particular orientation) and a transparent fluorolayer, this film then possibly being insert moulded with various substrates, for instance polyolefins or polyamides.

U.S. Pat. No. 5,725,712 proposes a thermoforming multilayer film obtained by lamination, consisting, from the inside outwards, of an adhesive layer, a pigmented layer in which the fillers have no particular orientation and a transparent layer.

U.S. Pat. No. 5,707,697 discloses a weatherproof decorated outer bodywork component. This component consists of a multilayer film obtained by the <<solvent cast>> technique followed by lamination, and of a substrate. The structure of the film comprises, from the inside outwards, a layer of chlorinated polyolefin capable of adhering to a polyolefin substrate, a pigmented fluoropolymer-based layer in which the fillers have no particular orientation, and a transparent fluoropolymer layer of glossy appearance.

Patent WO 96/40480 discloses a multilayer structure which, from the inside outwards, has a reinforcing layer (of ABS type) coated by co-extrusion with an adhesion primer (acrylic), then a coloured layer consisting of a PVDF-based copolymer blended with an acrylic, and a transparent surface layer consisting of a blend of PVDF homopolymer with an acrylic.

Patent WO 94/03337 proposes a multilayer consisting, from the inside outwards, of a substrate, of an adhesive layer consisting of a compound that is compatible with the substrate, of a reinforcing layer, of a coloured layer which contains pigments in an acrylic, urethane or vinyl matrix, and finally of a transparent layer based on PVDF and PMMA which has a composition gradient. The reinforcing layer may consist of PBT, PET, ABS, PVC, PA, polyester, PC, polyolefin, a copolymer of ethylene and of an alkyl (meth)acrylate, an acrylic polymer or a blend of at least any two of these polymers.

U.S. Pat. No. 5,658,670 discloses a bilayer film obtained by co-extrusion and hot-pressing of a layer of PVDF or derivatives and of a layer of PA, polyurethane or polyolefin modified with an amine.

Patent application JP 09 193 189 A published on Jul. 29, 1997 discloses a film comprising 4 layers which, from the inside outwards, are, respectively, a polypropylene layer, a filled (pigments) polypropylene layer, a layer of an ethylene-glycidyl methacrylate copolymer and a transparent surface layer based on polymethyl methacrylate (PMMA).

Patents FR 2 740 384 and FR 2 740 385 disclose a film with three or four layers based on polyamide and on chemically modified polypropylene, to produce decorated surfaces.

The technical Problem

In the films of the prior art, the weak point is the adhesion of the fluoropolymer layer to the other layers. Films have now been found in which the adhesion of the fluoropolymer layer is greatly improved. It has also been found, more generally, that multilayer films, used for protecting and decorating substrates, which have an outer layer made of fluoropolymer or acrylic polymer, can be easily decorated. The film of the invention is also much simpler to manufacture than that of the prior art, and in particular it requires no solvent.

### SUMMARY OF THE INVENTION

The present invention relates to a thermoforming multilayer film comprising, successively:

at least one layer chosen from layers (A1) and (A2) and such that, if (A2) is present, then (A2) is placed next to the optional layer (B1),

optionally a layer (B1),

a layer (B2),

a layer (B3)

and optionally a layer (B4), in which

the layer (A1) comprises a fluoropolymer (A111) or a polymer (A112) consisting essentially of alkyl (meth)acrylate units or a blend of the two,

the layer (A2) consists of ink,

the layer (B1) comprises a fluoropolymer (B111) or a polymer (B112) consisting essentially of alkyl (meth)acrylate units or a blend of the two,

the layer (B2) is based on polyamide with amine end groups,

the layer (B3) consists of a polyolefin functionalized with an unsaturated carboxylic anhydride,

and the layer (B4) is made of polyolefin.

According to one particular form of the invention, the layer (A1) is replaced with two layers (A11) and (A12), the order of the layers being as follows:

(A11)/(A12)/optional (A2)/optional (B1)/(B2)/(B3)/optional (B4),

the layer (A11) comprises a fluoropolymer (A111) or a polymer (A112) consisting essentially of alkyl (meth)acrylate units or a blend of the two,

the layer (A12) comprises, by weight, 0 to 50% of a fluoropolymer (A111) and 50 to 100% of a polymer (A112) consisting essentially of alkyl (meth)acrylate units.

It would not constitute a departure from the context of the invention if the various layers mentioned above contained impact modifiers, pigments, inks or additives for improving the external ageing resistance, such as anti-ultraviolet absorbers or antioxidants.

This film is obtained by co-extrusion of the various layers; they may all be co-extruded, at least two of them may be co-extruded and the other layers may then be layered either separately or by co-extrusion, or any combination of these possibilities. Advantageously, a film comprising the layers (B) and a film comprising the layers (A) are manufactured separately and are hot-assembled. All the layers (B) may also be placed simultaneously by co-extrusion layering onto the film manufactured beforehand, consisting of the layers (A).

If the layers (A) comprise ((A1) or ((A11) and (A12))) and (A2), then the layer (A2) is advantageously a layer placed onto the layer (A1) or (A12).

If the layers (A) comprise only (A2), then the film consisting of the layers (B) is first manufactured and the layer (A2) is then placed on the layer (B2) or on the optional layer (B1), if it exists. In this variant, once the layer (A2) has been applied, it may be coated with a varnish.

The film consisting of the layers (A) and (B) may comprise a protective layer applied to the outermost layer (A) of the film, i.e. (A1) or (A11) or (A2) or the varnish which is on (A2). This protective layer may be applied from the start of manufacture of the film consisting of the layers (A), provided that, of course, it consists only of (A2), or it may be applied after assembly with the layers (B).

A film is obtained which is coloured or decorated by means of the layer (A2) and/or the pigments or inks which may be added to the other layers.

This film is then used to cover various substrates, for example by injection-moulding the molten substrate over the multilayer film placed in the bottom of an injection mould, the film being placed against the wall of the mould on the side of the layers (A).

The present invention also relates to substrates coated with these films.

### DETAILED DESCRIPTION OF THE INVENTION

As regards the layers (A) comprising (A1) or (A11) and (A12), this assembly of layers is formed from a polymer or from a blend of polymers for obtaining a transparent, glossy surface which is resistant to chemical or external attack or to UV.

The layer (A2) consists of ink which may be applied to (A1) or (A12) by any technique known in the prior art (heliographic printing, flexographic printing, silk screen printing, offset printing, sublimation or transfer printing).

This assembly of layers (A) advantageously has a thickness of from 1 to 200 μm and preferably from 5 to 140 μm.

Examples of fluoropolymers (A111) which will be mentioned most particularly are

PVDFs, vinylidene fluoride (VF2) homopolymers and copolymers of vinylidene fluoride (VF2) preferably containing at least 50% by weight of VF2 and at least one other fluoromonomer such as chlorotrifluoroethylene (CTFE), hexafluoropropylene (HFP), trifluoroethylene (VF3) or tetrafluoroethylene (TFE),

trifluoroethylene (VF3) homopolymers and copolymers,

copolymers, and in particular terpolymers, combining residues of chlorotrifluoroethylene (CTFE), tetrafluoroethylene (TFE), hexafluoropropylene (HFP) and/or ethylene units and optionally VF2 and/or VF3 units.

Among these fluoropolymers (A111), PVDF is advantageously used. It would not constitute a departure from the context of the invention to use a blend of polymers (A111).

It is recommended to add the other polymer (A112) to the layers (A1) and (A11), thereby increasing the adhesion with the optional layer (A2) or the layer (A12) or the next layer (B).

These polymers (A112) consisting essentially of alkyl (meth)acrylate units may also comprise acid, acid chloride, alcohol or anhydride functions.

Examples of polymer (A112) which may be mentioned include homopolymers of an alkyl (meth)acrylate. Alkyl (meth)acrylates are described in Kirk-Othmer, Encyclopaedia of chemical technology, 4^{th} edition, in Vol. 1, pages 292-293 and in Vol. 16, pages 475-478. Mention may also be made of copolymers of at least two of these (meth)acrylates and copolymers of at least one (meth)acrylate with at least one monomer chosen from acrylonitrile, butadiene, styrene and isoprene, provided that the proportion of (meth)acrylate is at least 50 mol %. (A112) is advantageously PMMA. These polymers (A112) either consist of the monomers and optionally of the comonomers mentioned above and do not contain any impact modifier, or they also contain an acrylic impact modifier. The acrylic impact modifiers are, for example, random or block copolymers of at least one monomer chosen from styrene, butadiene and isoprene and of at least one monomer chosen from acrylonitrile and alkyl (meth)acrylates, and they may be of core-shell type. These acrylic impact modifiers may be mixed with the polymer (A112) once prepared or may be introduced during the polymerization of (A112) or prepared simultaneously during the polymerization of (A112). The amount of acrylic impact modifier may be, for example, from 0 to 60 parts per 100 to 40 parts of (A112). It would not constitute a departure from the context of the invention if (A112) was a blend of two or more of the above polymers.

Suitable polymers (A112) are SUMIPEX TR® from Sumitomo and OROGLASS HT121® from Atoglass and, for (A111), KYNAR 720® from ATOFINA. This layer may contain various organic and/or inorganic fillers, for example UV absorbers of the TINUVIN® family from Ciba Speciality Chemicals, and this layer may also contain pigments or colorants. This layer has very good resistance to the various fluids used in motor vehicles, such as petrol, coolant fluid, wiper-washer liquid, brake fluid, engine oil and hydraulic transmission fluid. Very good conservation over time of the surface condition and appearance of the film is obtained.

Using the extrusion technique, it is possible to obtain an orientation in the direction of flow of the pigments or colorants in this layer, making the appearance of the film anisotropic. All that will be needed to do this is to use pigments with an anisotropic aspect ratio. By selecting pigments with an isotropic aspect ratio (aspect ratio in the region of 1), this effect may be advantageously eliminated. This orientation of the pigments gives an interference effect.

As regards the layers (A) constituting the sole layer (A2), this layer (A2) is applied onto the optional layer (B1) or onto the layer (B2). The process is performed as for the application of (A2) onto (A1) or (A12).

As regards the layer (B1), the fluoropolymer (B111) may be chosen from the polymers (A111) mentioned above; it may be identical to or different from the polymer(s) used in the layers (A). The polymer (B112) may be chosen from the polymers (A112) mentioned above; it may be identical to or different from the polymer(s) used in the layers (A). As for the layers (A), the polymers (B111) and (B112) may be polymer blends.

The polyamide of the layer (B2) is a polyamide homopolymer or copolymer with amine end groups or a blend of polyamides, at least one containing amine end groups. The term “polyamide” means the products of condensation:

of one or more amino acids, such as aminocaproic acid, 7-aminoheptanoic acid, 11-aminoundecanoic acid or 12-aminododecanoic acid or one or more lactams such as caprolactam, oenantholactam or lauryllactam;

of one or more salts or blends of diamines such as hexamethylenediamine, dodecamethylenediamine, meta-xylylenediamine, bis(p-aminocyclohexyl)methane or trimethylhexamethylenediamine with diacids such as isophthalic acid, terephthalic acid, adipic acid, azelaic acid, suberic acid, sebacic acid and dodecanedicarboxylic acid.

Examples of polyamide which may be mentioned are PA 6, PA 6-6, PA 11 and PA 12.

Copolyamides may also advantageously be used. Mention may be made of copolyamides resulting from the condensation of at least two α,ω-aminocarboxylic acids or of two lactams or of a lactam and an α,ω-aminocarboxylic acid. Mention may also be made of copolyamides resulting from the condensation of at least one α,ω-aminocarboxylic acid (or a lactam), at least one diamine and at least one dicarboxylic acid.

Examples of lactams which may be mentioned are those containing from 3 to 12 carbon atoms on the main ring and which may be substituted. Mention may be made, for example, of β,β-dimethylpropiolactam, α,α-dimethylpropiolactam, amylolactam, caprolactam, capryllactam and lauryllactam.

As examples of α,ω-aminocarboxylic acids, mention may be made of aminoundecanoic acid and aminododecanoic acid. As examples of dicarboxylic acids, mention may be made of adipic acid, sebacic acid, isophthalic acid, butanedioic acid, 1,4-cyclohexanedicarboxylic acid, terephthalic acid, the sodium or lithium salt of sulphoisophthalic acid, dimerized fatty acids (these dimerized fatty acids have a dimer content of at least 98% and are preferably hydrogenated) and dodecanedioic acid HOOC—(CH₂)₁₀—COOH.

The diamine may be an aliphatic diamine containing from 6 to 12 atoms, and may be arylic and/or saturated cyclic. Examples which may be mentioned are hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, diamine polyols, isophoronediamine (IPD), methylpentamethylenediamine (MPDM), bis(aminocyclohexyl)methane (BACM) and bis(3-methyl-4 -aminocyclohexyl)methane (BMACM).

As examples of copolyamides, mention may be made of copolymers of caprolactam and of lauryllactam (PA 6/12), copolymers of caprolactam, of adipic acid and of hexamethylenediamine (PA 6/6-6), copolymers of caprolactam, of lauryllactam, of adipic acid and of hexamethylenediamine (PA 6/12/6-6), copolymers of caprolactam, of lauryllactam, of 11-aminoundecanoic acid, of azelaic acid and of hexamethylenediamine (PA 6/6-9/11/12), copolymers of caprolactam, of lauryllactam, of 11-aminoundecanoic acid, of adipic acid and of hexamethylenediamine (PA 6/6-6/11/12), copolymers of lauryllactam, of azelaic acid and of hexamethylenediamine (PA 6-9/12). The copolyamide is advantageously chosen from PA 6/12 and PA 6/6-6. The advantage of these copolyamides is their melting point, which is lower than that of PA 6.

In order to obtain amine end groups, it suffices to carry out the synthesis in the presence of an excess of diamine or, for polyamides (and copolyamides) which are manufactured using a lactam or an α,ω-aminocarboxylic acid, to use a diamine or a monoamine as chain limiter.

Examples which may be mentioned are (1) blends of miscible polyamides and (2) one-phase blends resulting from the transamidation of polyamide and of amorphous semi-aromatic polyamide. Blends that are advantageous are those that are still crystalline and transparent, i.e. monocrystalline, for example blends comprising, by weight, 70% of PA 12 and 30% of PA 12/ BMACM- I/BMACM- T, <<I>>and <<T>> denoting, respectively, isophthalic acid and terephthalic acid. Mention may also be made of PA BMACM- 12 and PA PACM- 12 (PACM represents para-aminodicyclohexylmethane).

It would not constitute a departure from the context of the invention to use blends of polyamides with a polyolefin. Advantageously, these blends have a polyamide matrix, i.e. they contain (by weight) 55 to 100 parts of polyamide per 0 to 45 parts of polyolefin; the polyolefin may be functionalized or may be a blend of a functionalized polyolefin and a non-functionalized polyolefin. By way of example, the functionalized polyolefins and non-functionalized polyolefins described may be used in the layer (D).

One polyamide which is particularly suitable is PA 12 AESNO TL® from ATOFINA, which makes it possible, if (B2) contains functions, to produce via a chemical reaction a covalent bond which is stable over time with the anhydride, acid, acid chloride or alcohol functions present in another layer in contact with (B2). The thickness of this layer is advantageously between 5 and 200 μm and preferably between 70 and 140 μm. This layer may contain various organic and/or inorganic fillers, for example UV absorbers of the TINUVIN® family from Ciba Speciality Chemicals; this layer may also contain pigments or colorants.

Using the extrusion technique, it is possible to obtain an orientation in the direction of flow of the pigments or colorants in this layer, making the appearance of the film anisotropic. All that will be needed to do this is to use pigments with an anisotropic aspect ratio. By selecting pigments with an isotropic aspect ratio (aspect ratio in the region of 1), this effect may be advantageously eliminated. This orientation of the pigments gives an interference effect.

The layer (B3) consists of a polyolefin functionalized with an unsaturated carboxylic anhydride. The presence of the anhydride function allows an imidation reaction with the amine functions of the layer (B2), thus allowing the formation of a bond which is stable over time. This functionalized polyolefin is often described in the prior art by the term “co-extrusion binder”.

A polyolefin is conventionally a homopolymer or copolymer of α-olefins or of diolefins, such as, for example, ethylene, propylene, 1-butene, 1-octene or butadiene. By way of example, mention may be made of:

polyethylene homopolymers and copolymers, in particular LDPE, HDPE, LLDPE (linear low density polyethylene), VLDPE (very low density polyethylene) and metallocene polyethylene,

propylene homopolymers or copolymers,

ethylene/a-olefin copolymers such as ethylene/propylene, EPR (abbreviation for ethylene-propylene-rubber) and ethylene/propylene/diene (EPDM) copolymers,

styrene/ethylene-butene/styrene (SEBS), styrene/butadiene/styrene (SBS), styrene/isoprene/styrene (SIS) and styrene/ethylene-propylene/styrene (SEPS) block copolymers,

copolymers of ethylene with at least one product chosen from the salts or esters of unsaturated carboxylic acids, such as alkyl (meth)acrylate (for example methyl acrylate) or the vinyl esters of saturated carboxylic acids such as vinyl acetate, the proportion of comonomer possibly being up to 40% by weight.

The functionalized polyolefin of the layer (B3) may be an α-olefin polymer containing unsaturated carboxylic anhydride units. Examples which may be mentioned are the above polyolefins grafted or copolymerized with unsaturated carboxylic anhydrides. The grafting processes are known to those skilled in the art. It would not constitute a departure from the context of the invention to use unsaturated carboxylic acids, and also derivatives of these acids and anhydrides. Examples which may be mentioned are acrylic acid, methacrylic acid, maleic acid, fumaric acid, itaconic acid, crotonic acid, itaconic anhydride, nadic anhydride, maleic anhydride and substituted maleic anhydrides such as, for example, dimethylmaleic anhydride. Examples of derivatives which may be mentioned are salts, amides, imides and esters, such as sodium mono- and dimaleate, acrylamide, maleimide and dimethyl fumarate. (Meth)acrylic acid may be totally or partially neutralized with metals such as Zn, Ca or Li. A functionalized polyolefin is, for example, a PE/EPR blend, in which the weight ratio may vary within a wide range, for example between 40/60 and 90/10, the said blend being co-grafted with an anhydride, in particular maleic anhydride, to a degree of grafting of, for example, from 0.01% to 5% by weight.

Advantageously, (B3) is based on polypropylene, for example essentially comprising polypropylene homopolymer or copolymer functionalized by grafting with at least one unsaturated carboxylic acid, an unsaturated carboxylic anhydride or derivatives of these acids and anhydrides. These products have already been mentioned above. Advantageously, polypropylene with an MFI (abbreviation for the melt flow index) of 0.1 to 10 g/10 min (at 230° C. under 2.16 kg) is grafted with maleic anhydride in the presence of initiators such as peroxides. The amount of maleic anhydride effectively grafted may be between 0.01% and 10% by weight of the grafted polypropylene. The grafted polypropylene may be diluted with polypropylene, EPR rubber, EPDM rubber or copolymers of propylene and of an α-olefin. According to another variant, a co-grafting of a blend of polypropylene and of EPR or EPDM may also be carried out, i.e. an unsaturated carboxylic acid, an anhydride or derivatives thereof may be added to a blend of polypropylene and of EPR or EPDM in the presence of an initiator.

As other examples of constituents of the layer (B3), mention may be made of blends comprising, by weight:

0 to 50% and preferably 10 to 40% of at least one polyethylene or one ethylene copolymer,

50 to 100% and preferably 60 to 90% of at least one polymer chosen from polypropylene or a propylene copolymer, poly(1-butene) homopolymer or copolymer and polystyrene homopolymer or copolymer, and preferably polypropylene,

these blends being grafted with a functional monomer chosen from carboxylic acids and derivatives thereof, acid chlorides, isocyanates, oxazolines, epoxides, amines and hydroxides, and preferably unsaturated dicarboxylic anhydrides,

these grafted blends optionally being diluted in at least one polyolefin essentially comprising propylene units or in at least one polymer of elastomeric nature or in a blend thereof.

Polymers which may be used for this layer (B3) are, for example, the grafted polypropylenes from Atofina and DuPont sold, respectively, under the brand names Orevac PPFT® and Bynel 50E561®.

The thickness of this layer is advantageously between 10 and 250 μm and preferably between 40 and 110 μm. This layer may contain various organic and/or inorganic fillers, for example UV absorbers of the Tinuvin® family from Ciba Speciality Chemicals; this layer may also contain pigments or colorants.

Using the extrusion technique, it is possible to obtain an orientation in the direction of flow of the pigments or colorants in this layer, making the appearance of the film anisotropic. All that will be needed to do this is to use pigments with an anisotropic aspect ratio. By selecting pigments with an isotropic aspect ratio (aspect ratio in the region of 1), this effect may be advantageously eliminated. This orientation of the pigments gives an interference effect. (B3) may also be a blend of several grafted polyolefins.

The binder layer (B4) which allows bonding with the substrate is a polyolefin; the polyolefins have been defined in the layer (B3). The compatibility and affinity of these materials are sufficient to allow bonding with the layer (B3) and the substrate. Polypropylene is advantageously used. Materials that are entirely suitable for producing this layer are the polypropylenes 3050 BN1, 3060 MN5 and CZN 0525 from the company Atofina. This layer is advantageously between 400 and 800 μm thick and preferably between 500 and 600 μm thick. This layer may contain various organic and/or inorganic fillers, for example UV absorbers of the Tinuvin® family from Ciba Speciality Chemicals, and this layer may also contain pigments or colorants.

Using the extrusion technique, it is possible to obtain an orientation in the direction of flow of the pigments or colorants in this layer, making the appearance of the film anisotropic. All that will be needed to do this is to use pigments with an anisotropic aspect ratio. By selecting pigments with an isotropic aspect ratio (aspect ratio in the region of 1), this effect may be advantageously eliminated. This orientation of the pigments gives an interference effect.

The protective layer applied onto the outermost layer (A) of the film is a temporary layer for protecting the film during its handling, thermoforming and injection moulding. This protective layer makes it possible to maintain or promote a given surface state. Thus, this layer may be smooth or rough according to the desired surface state. This layer avoids the use of a mould-release agent which may degrade the surface state of the film. This layer is advantageously between 10 and 150 μm thick and preferably from 50 to 100 μm thick. The materials which may be used to produce this layer may be chosen from (i) saturated polyesters such as PET, PBT, copolyesters and polyether esters, and (ii) polyolefin homopolymers or copolymers such as polyethylenes and polypropylenes. Examples which may be mentioned are the PET sold under the brand name Mylar by the company DuPont. This layer may contain various fillers, such as TiO₂, silica, kaolin, calcium carbonate or aluminium flakes, and derivatives thereof.

As regards the manufacture of the film of the invention and its use, the compositions of the various layers may be made by the usual techniques for melt-blending constituents, in which the other constituents such as the optional fillers (pigments, inks, UV stabilizers, etc.) are added. The film is advantageously manufactured by co-extrusion.

The film of the invention is manufactured by co-extrusion according to a common technique of thermoplastics in which the molten material of the various layers is forced through flat dies arranged very close to each other, and the combination of molten materials forms the multilayer film which is cooled by passing it over rollers at controlled temperature. By adjusting the speeds of rollers arranged in the longitudinal direction and/or of rollers arranged in the transverse direction, the material may be drawn in the longitudinal direction and/or in the transverse direction.

The MFI values of the various layers are chosen to be as close together as possible, between 1 and 20 (at 230° C., 2.16 kg), and the MFI values are advantageously between 4 and 7; this choice falls within the competence of a person skilled in the art of co-extrusion.

The multilayer film of the invention is useful for coating substrates by insert moulding, co-extrusion, layering or hot-press moulding. The technique of insert moulding is advantageously used. If the mould is of simple shape, it suffices to inject the molten substrate to plate the film against the wall of the mould; in this case, the film is used as obtained. If the mould is of a more complex shape, to avoid stresses in the film and to ensure good contact of the film with the walls of the mould, it is necessary to preform the film by thermoforming before placing it in the mould. Another mould of the same shape may be used, and with the aid of a component of the same shape but in positive relief, the film is thermoformed; the same mould which was used for the injection moulding of the substrate may also be used. For conditions intermediate between those above, it is also possible not to carry out thermoforming, but to place the film directly into the mould and, with compressed air on the side on which the substrate is injected, to plate the film onto the wall of the mould. A vacuum may also be applied to the other side of the film in order to plate it against the wall of the mould.

If the film needs to be thermoformed, the products used will have to have a thermoforming temperature range which has the broadest possible region of overlap. By way of example, the melting point (Tm), the minimum thermoforming temperature (THF MIN) and the maximum thermoforming temperature (THF MAX) of various constituents of the layers of the film of the invention are given in Table 1 below.

TABLE 1
Thermoforming temperature range

| | | | THF |
|---|---|---|---|
| PRODUCT | Tm (° C.) | THF MIN. | MAX. |
| polypropylene homopolymer | 165-175 | Tm − 25° C. | Tm + 5° C. |
| polypropylene copolymer | 160-171 | Tm − 20° C. | Tm + 30° C. |
| maleized polypropylene | 160-175 | Tm − 25° C. | Tm + 5° C. |
| PA 6 | 210-221 | Tm − 25° C. | Tm + 5° C. |
| PA 6/6-6 | 180-190 | Tm − 25° C. | Tm + 20° C. |
| PA 11 | 183-192 | Tm − 25° C. | Tm + 5° C. |
| PA 12 | 178-180 | Tm − 25° C. | Tm + 5° C. |
| Blend of PA 6 and polyolefin | 200-225 | Tm − 25° C. | Tm + 5° C. |
| PVDF homopolymer | 168-172 | Tm − 25° C. | Tm + 5° C. |
| PMMA | Tg = 90-105 | Tg + 20° C. | Tg + 60° C. |
| PVDF/PMMA (60/40) | 168-172 | Tm − 25° C. | Tm + 5° C. |

The various layers may contain fillers and additives, provided that the transparency properties of the top layer (B) and the colours and colour effects of the assembled structure are not affected.

The invention is particularly useful for coating polypropylene substrates.

The preceding example can be repeated with similar success by substituting the generically or specifically described reactants and/or operating conditions of this invention for those used in the preceding example. Also, the preceding specific embodiments are to be construed as merely illustrative, and not limitative of the remainder of the disclosure in any way whatsoever.

The entire disclosure of all applications, patents and publications, and of corresponding French application 0100879, are hereby incorporated by reference.

From the foregoing description, one skilled in the art can easily ascertain the essential characteristics of this invention and, without departing from the spirit and scope thereof, can make various changes and modifications of the invention to adapt it to various usages and conditions.

1 Thermoforming multilayer film comprising, successively:
at least one layer chosen from layers (A1) and (A2) and such that, if (A2) is present, then (A2) is placed next
to the optional layer (B1), optionally a layer (B1),
a layer (B2),
a layer (B3)
and optionally a layer (B4), in which
the layer (A1) comprises a fluoropolymer (A111) or a polymer (A112) consisting essentially of alkyl (meth)acrylate units or a blend of the two,
the layer (A2) consists of ink,
the layer (B1) comprises a fluoropolymer (B111) or a polymer (B112) consisting essentially of alkyl (meth)acrylate units or a blend of the two,
the layer (B2) is based on polyamide with amine end groups,
the layer (B3) consists of a polyolefin functionalized with an unsaturated carboxylic anhydride,
and the layer (B4) is made of polyolefin.

2 Film according to claim 1, in which the layer (A1) is replaced with two layers (A11) and (A12), the order of the layers being as follows:
(A11)/(A12)/optional (A2)/optional (B1)/(B2)/(B3)/optional (B4),
the layer (A11) comprises a fluoropolymer (A111) or a polymer (A112) consisting essentially of alkyl (meth)acrylate units or a blend of the two,
the layer (A12) comprises, by weight, 0 to 50% of a fluoropolymer (A111) and 50 to 100% of a polymer (A112) consisting essentially of alkyl (meth)acrylate units.

3 Film according to either of the preceding claims, in which the fluoropolymer (B111) and (A111) is PVDF.

4 Film according to any one of the preceding claims, in which the polymer (B112) and (A112) is PMMA.

5 Film according to any one of the preceding claims, in which the polyamide of the layer (B2) is chosen from PA 6, PA 12 and PA 6/6-6, these polyamides containing amine end groups.

6 Film according to any one of the preceding claims, in which the functionalized polyolefin of the layer (B3) is grafted polypropylene optionally diluted with polypropylene, EPR rubber, EPDM rubber or copolymers of propylene and of an α-olefin.

7 Film according to any one of claims 1 to 5, in which the functionalized polyolefin of the layer (B3) results from a co-grafting of a blend of polypropylene and of EPR or EPDM.

8 Film according to any one of claims 1 to 5, in which the functionalized polyolefin of the layer (B3) is a blend comprising, by weight:
0 to 50% and preferably 10 to 40% of at least one polyethylene or one ethylene copolymer,
50 to 100% and preferably 60 to 90% of at least one polymer chosen from polypropylene or a propylene copolymer, poly.(1-butene) homopolymer or copolymer and polystyrene homopolymer or copolymer, and preferably polypropylene,
this blend being grafted with an unsaturated carboxylic anhydride,
this grafted blend optionally being diluted in at least one polyolefin essentially comprising propylene units or in at least one polymer of elastomeric nature or in a blend thereof.

9 Film according to any one of the preceding claims, in which the polyolefin of the layer (B4) is polypropylene.

10 Substrate coated with a film according to any one of the preceding claims, in which the layer (B3) or the layer (B4), if it exists, is next to the substrate.

11 Substrate according to claim 10, consisting of polypropylene.
